(19) United States
(12) Patent Application Publication
(10) Pub. No.: US 2008/0105207 A1
(43) Pub. Date: May 8, 2008

(54) WASTE RECEPTACLE

(76) Inventor: Theodore R. Gloor, Overland Park, KS (US)

Correspondence Address: MARK BROWN, 4700 BELLEVIEW SUITE 210, KANSAS CITY, MO, 64112, US

(21) Appl. No.: 11/971,768

(22) Filed: Jan. 9, 2008

Related U.S. Application Data
(63) Continuation-in-part of application No. 11/652,944, filed on Jan. 12, 2007.
(60) Provisional application No. 60/759,156, filed on Jan. 13, 2006.

(51) Int. Cl. A01K 29/00

(52) U.S. Cl. 119/161

(57) ABSTRACT

A waste disposal system includes a receptacle with a base adapted to receive a waste tray assembly on a top panel thereof. The top panel includes an inlet drain opening. A discharge drain is provided in the receptacle base. The waste tray assembly can include natural or artificial turf, and is removable from the top panel. A cover can be mounted on the receptacle base and can be movable between open and closed positions. Alternatively, a lid can be provided for removable mounting on the receptacle base. An alternative embodiment waste receptacle includes a disposal system with a base adapted to receive a waste tray assembly on a top panel thereof. The top panel includes drain holes. A liquid waste container is housed beneath the base. A discharge spout is provided in the waste container. The waste tray assembly can include natural or artificial turf, and is removable from the top panel. The base rests on the ground and allows liquid waste to pass through the waste tray assembly and into a removable container located underneath.

### CROSS-REFERENCE TO RELATED APPLICATION

This application is a continuation-in-part of and claims priority in U.S. patent application Ser. No. 11/652,944, filed Jan. 12, 2007, which claims priority in U.S. Provisional Patent Application No. 60/759,156, filed Jan. 13, 2006, both of which are incorporated herein by reference.

### BACKGROUND OF THE INVENTION

1. Field of the Invention

The present invention relates generally to waste receptacles, and in particular to an enclosable waste receptacle which is particularly adapted for use by small domestic animals.

2. Description of the Related Art

Domestic companion animals, particularly dogs and cats, are very popular among pet owners. However, waste handling is an unpleasant but significant aspect of pet ownership. Urban pet owners who live in apartments and high-rise dwelling structures and owners who travel with their pets are frequently inconvenienced by waste-handling responsibilities. Such inconveniences can involve the need to let the pets out of the dwelling structures according to predetermined schedules. Such pet toilet needs can arise at inopportune times for the owners. Thus, owners may find themselves disengaging from business and personal matters and otherwise arranging their schedules in order to let their pets out and/or take them on walks for toilet purposes.

Another alternative solution to pet waste problems consists of pet waste receptacles, which can be used indoors. Previous configurations of pet waste receptacles include “litter boxes.” which generally absorb waste in dry litter material. The litter material must be frequently changed to avoid odor and related problems associated with accumulating waste material in open containers. Moreover, litter material can be scattered from an open container and must be collected to maintain a clean residence while coexisting with a pet trained or “house broken” for litter box use. Yet another prior art alternative consists of waste-absorbent paper pellets and pads. However, such disposable paper products tend to be somewhat cumbersome to handle and can be somewhat costly, particularly when they are replaced frequently.

Other prior art devices for collecting pet waste are shown in the Dennis U.S. Pat. No. 4,117,555; the Clark U.S. Pat. No. 4,979,469 and the Hochman U.S. Patent Publication No. 2004/0011297. Heretofore there is not been available a pet waste receptacle with the advantages and features of the present invention.

### SUMMARY OF THE INVENTION

A waste receptacle is provided, which includes a receptacle base with a top panel mounting an inlet drain assembly. The drain assembly includes a drain plug movable between open and closed positions. A turf assembly is adapted for placement on top of the receptacle base top panel and includes turf, felt and screen layers. An alternative embodiment waste receptacle includes a base with an angled drip tray forming a central dome support surrounded by a drain channel with drain holes. The base is adapted for placement over a liquid waste container.

### BRIEF DESCRIPTION OF THE DRAWINGS

FIG. 1 is an upper, front, left-side perspective view of a waste receptacle embodying the present invention, showing a turf or waste tray assembly thereof being removed and folded.

FIG. 2 is another perspective view thereof, particularly showing a removable turf inset feature.

FIG. 3 is another perspective view thereof, particularly showing the waste receptacle in a closed, storage/transport position.

FIG. 4 is a top plan thereof, with portions of the turf or waste tray assembly broken away to reveal internal construction.

FIG. 5 is a front elevational view thereof, showing the cover in a raised position in broken lines.

FIG. 6 is a right-side elevational view thereof.

FIG. 7 is a fragmentary, vertical, cross-sectional view of a hinge taken generally along line 7 in FIG. 4.

FIG. 8 is a vertical, cross-sectional view taken generally along line 8/9 in FIG. 4 and particularly showing an inlet drain assembly in an open position thereof.

FIG. 9 is a vertical, cross-sectional view taken generally along line 8/9 in FIG. 4 and particularly showing the inlet drain assembly in a closed position thereof.

FIG. 10 is a fragmentary, top plan view taken generally along line 10 in FIG. 6 and particularly showing a discharge valve assembly.

FIG. 11 is an upper, perspective view of an alternative, circular turf inset configuration.

FIG. 12 is a right-side elevational view of an alternative embodiment waste receptacle with a pair of covers.

FIG. 13 is an upper, front, left-side perspective view of another alternative embodiment waste receptacle with an optional cargo rack removably mounted over the cover.

FIG. 14 is an upper, front, right-side perspective view of another alternative embodiment waste receptacle.

FIG. 15 is a bottom plan view thereof.

FIG. 16 is a right-side elevational view thereof.

FIG. 17 is an enlarged, fragmentary, cross-sectional view thereof, taken generally along line 17 in FIG. 14.

FIG. 18 is a rear elevational view thereof.

FIG. 19 is an enlarged, fragmentary, perspective view of a discharge drain thereof.

FIG. 20 is a top plan view of another alternative embodiment waste receptacle.

FIG. 21 is a cross section thereof, taken generally along line 21 in FIG. 20, as well as an isometric view of the liquid waste container.

FIG. 22 is an enlarged, fragmentary cross section taken generally in circle 22 in FIG. 21 and showing a drain channel and a drain hole.

### DETAILED DESCRIPTION OF THE PREFERRED EMBODIMENTS

I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Forwardly and rearwardly are generally in reference to the direction of travel, if appropriate. Said terminology will include the words specifically mentioned, derivatives thereof and words of similar meaning.

II. Embodiment or Aspect of the Invention 2

Referring to the drawings in more detail, the reference numeral 2 generally designates a waste receptacle embodying the present invention. Without limitation on the generality of useful applications of the waste receptacle 2, an exemplary application, described herein, is for receiving, storing and discharging waste from small domestic animals. such as cats and dogs. The waste receptacle 2 is scalable and thereby adaptable for animals and residences of various sizes.

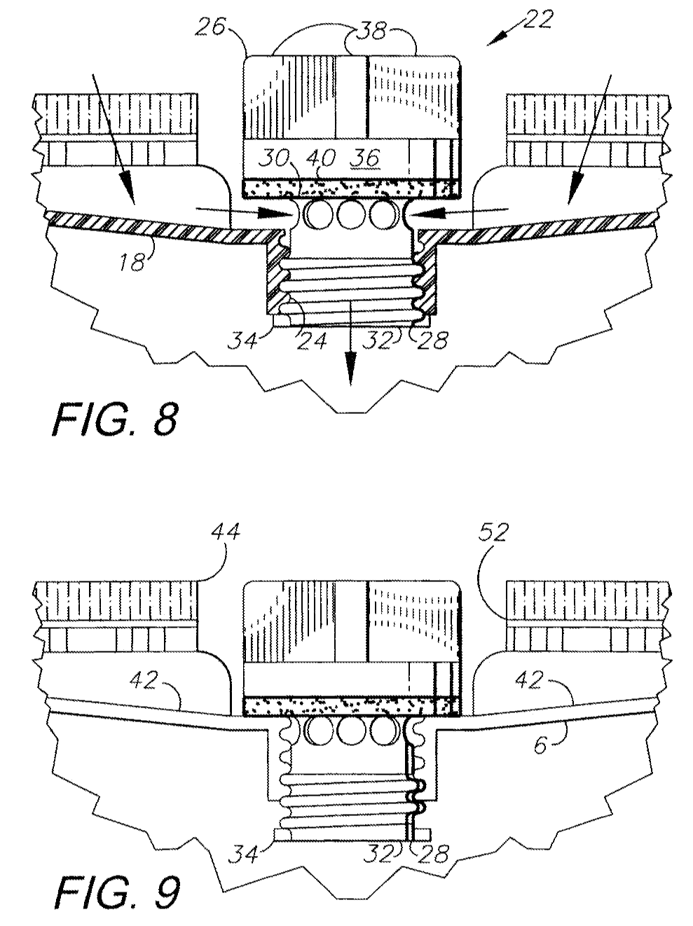

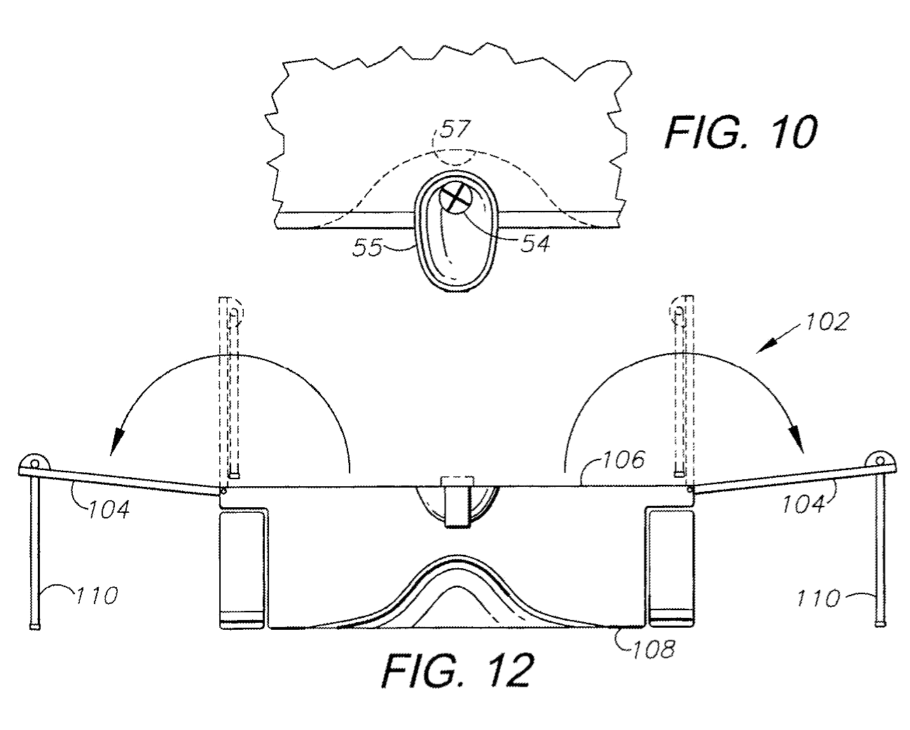

The waste receptacle 2 includes a receptacle base 4 with top and bottom panels 6. 8; sidewalls 10, 12; front and back walls 14, 16; and an interior compartment 18 enclosed thereby. A rim 20 is formed by the tops of the walls 10, 12, 14, 16 and extends above the top panel 6 to form an upwardly-open waste receiver 21. An inlet drain assembly 22 includes a female-threaded inlet drain port 24 in the top panel and an inlet drain plug 26 threadably received therein. The drain plug 26 includes a male-threaded, tubular body 28 with upper and lower ends 30, 32. Retaining lugs 34 project radially outwardly from the body lower end 32 and are adapted for limiting upward travel of the drain plug 26 by engaging the inlet drain port 24 at the upper limit of the travel of the drain plug 26. It will be appreciated that various types of stop and interference structures could be provided for restricting upward travel of the drain plug 26. A head 36 is mounted on the drain plug body upper end 30 and includes multiple tabs 38, which facilitate twisting the drain plug 26 for raising and lowering same. An elastomeric washer or gasket 40 is located below the head 36 for engaging the top panel 6 in a sealing relationship with the inlet drain assembly closed (FIG. 8).

The top panel 6 includes multiple channels 42, which extend radially inwardly from the rim 20 to the inlet drain assembly 22 and slope downwardly for liquid drainage through the open inlet drain assembly (FIG. 8). A turf assembly 44 is removably placed in the waste receiver 21 on top of the top panel 6 and includes a screen layer 46, a felt layer 48 and a turf layer 50 with a central opening 52 for receiving the drain plug 26. The turf assembly 44 is preferably flexible whereby it can be folded double upon removal for disposing of solid waste, cleaning, changing the turf layer 50, etc. The layers 46, 48 and 50 comprising the turf assembly 44 are preferably permeable for passing liquid therethrough and trapping solid waste thereon. The screen layer 46 can be provided with handles 47 for removing and transporting the turf assembly 44 with little or no contact with its surfaces. An example of an artificial turf material comprising 50 is produced by SYNLawn, Inc. of Orlando, Fla. The turf assembly 44 can comprise a single layer of, for example, artificial or natural turf placed directly on the receptacle base top panel 6, thus eliminating the screen and felt layers 46, 48. Such a single-layer construction would preferably utilize a permeable turf layer 50.

The receptacle base 4 includes wheels 39 partly recessed into its front and back walls 14, 16 adjacent to the sidewall 12. Optionally, the wheels 39 can be omitted. Also, detachable wheeled structures can be substituted for the wheels 39 for transporting the receptacle 2. The receptacle base 4 is adapted for standing upright on the left sidewall 10, the right sidewall 12, the front wall 14 or the back wall 16. A telescoping, retractable handle 41 extends from the opposite sidewall 10. The sidewalls 10, 12 mount discharge valve assemblies 51, 53, which threadably receive discharge plugs 54 and are adapted to drain or flush the interior compartment 18 with the discharge plugs 54 in their respective open positions. The discharge plugs 54 and the other discharge valve assembly 51, 53 components can be similar to the construction of the drain valve assembly 22. A spout 55 projects outwardly from the side wall 12 adjacent to the discharge valve assembly 53 to facilitate pouring the receptacle base 4 contents into a disposal, such as a toilet. The spout 55 includes a leg 59 at its outer end, which is adapted for hooking the rim of a toilet bowl within positioning the receptacle 2 for discharging its contents into a toilet or other disposal receptacle. The spout leg 59 also supports the receptacle 2 on a flat surface in an upright position, with additional support being provided by the wheels 39. The sidewall 12 has a recess 57, which is adapted to receive the rim of a toilet bowl to facilitate properly positioning the receptacle base 4 for discharging via the spout 55.

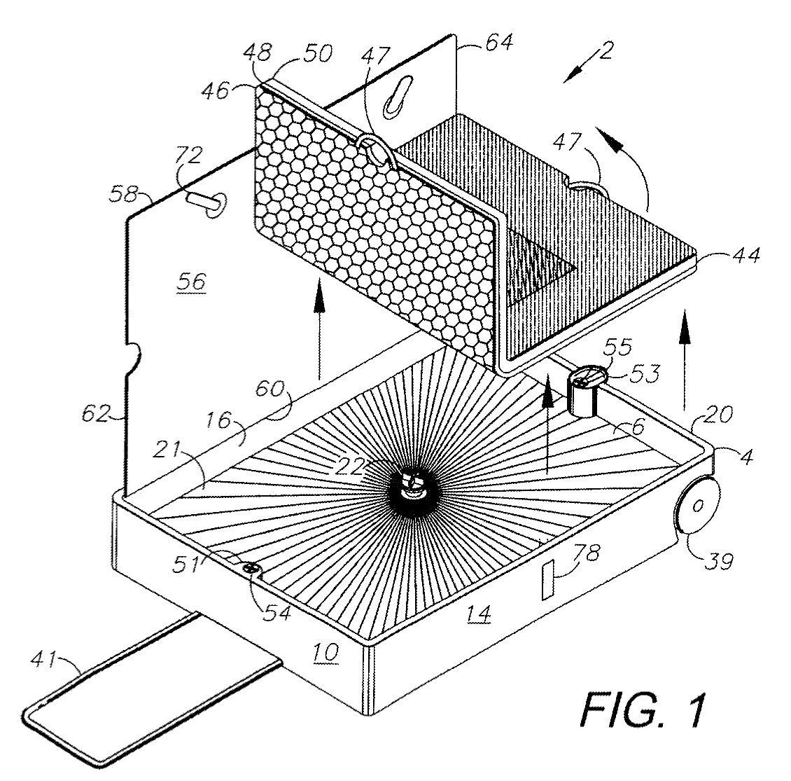

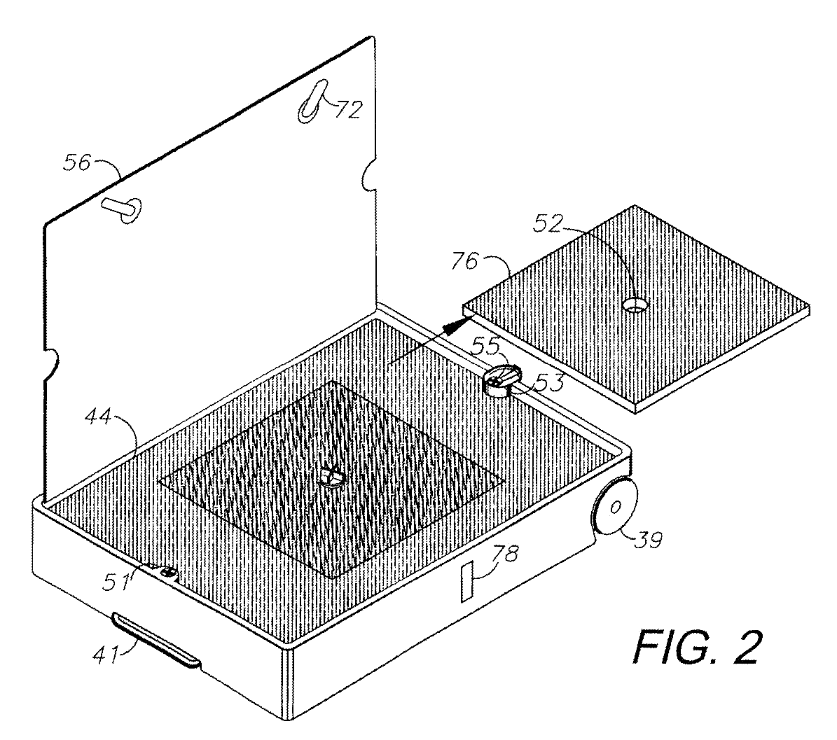

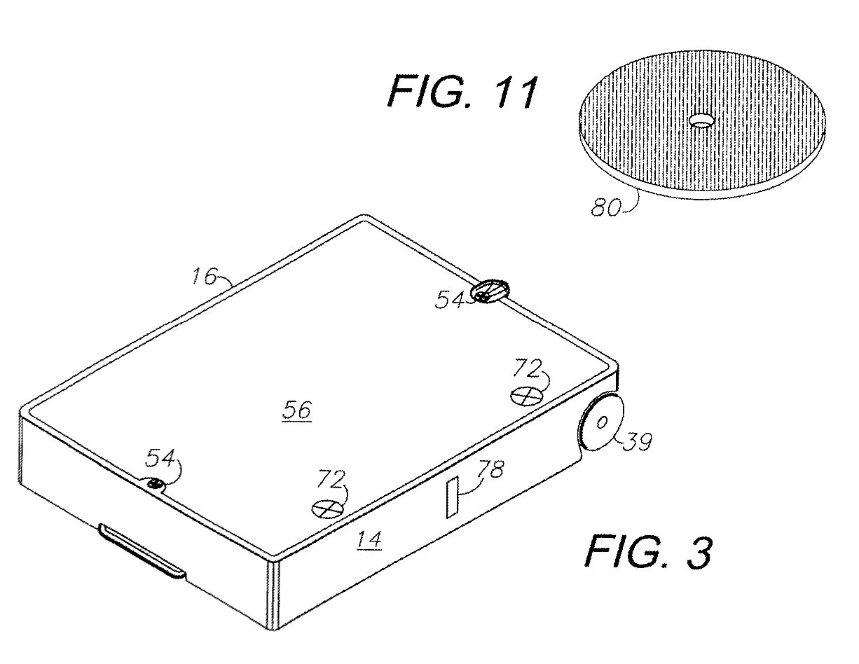

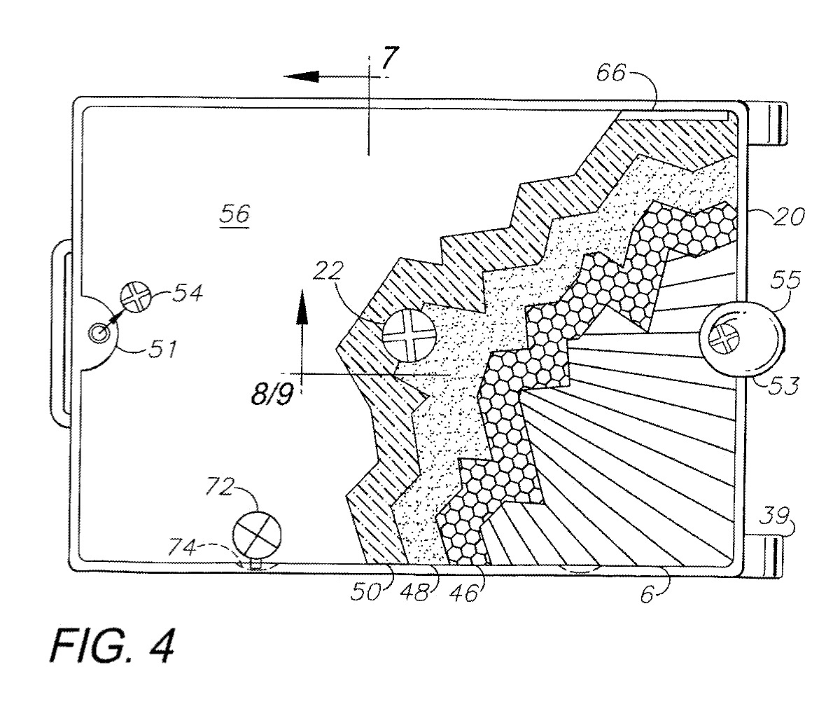

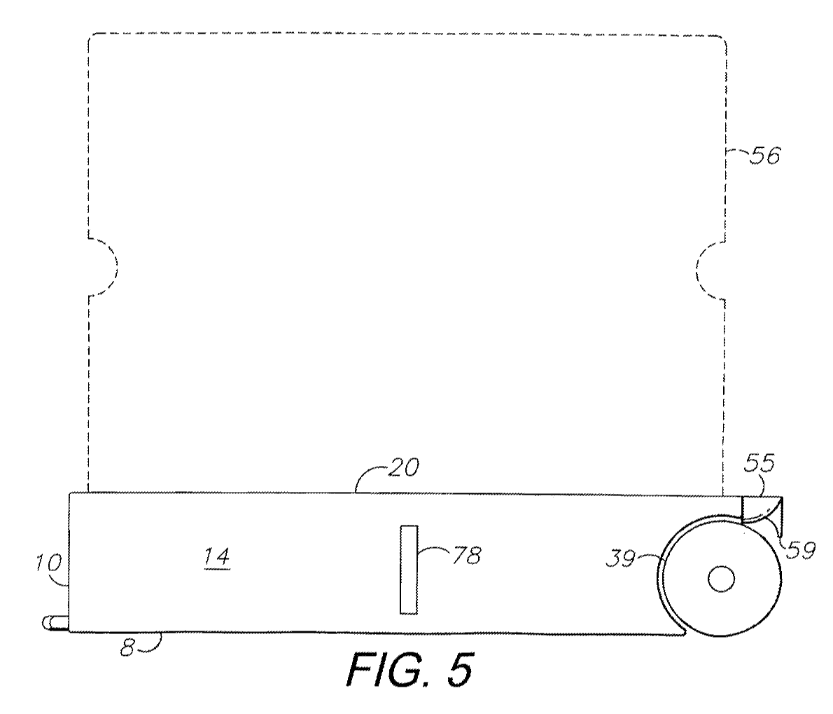

A cover 56 includes front, back and opposite side edges 58, 60, 62, 64 and a hinge 66 comprising an upwardly-open channel 68 with drain holes 69 formed in the rim 20 at the top of the back wall 16 and a hinge shaft 70 formed at the cover back edge 60 and rotatably received in the channel 68. The hinge shaft 70 can be snapped into the channel 68 for expediting removal of the cover 56. The hinge 66 permits the cover 56 to move between a closed, generally horizontal position (FIG. 3) and an open, generally vertical position (FIGS. 1 and 2), i.e. through about 90°. The hinge 66 can have a relatively tight interference fit for maintaining the cover 56 in its open position, or other suitable mechanisms, such as braces. can be utilized for propping the cover 56 open. The cover 56 is provided with a pair of latches 72 located in proximity to its front edge 58 and adapted for selectively engaging slots 74 formed in the front wall 14 whereby the cover 56 can be secured in a closed position over the turf assembly 44. The hinge 66 can be configured to allow the cover 56 to swing through approximately 180° to horizontal or slightly-sloping position, thus effectively doubling the surface area of the waste receptacle 2 in its open position.

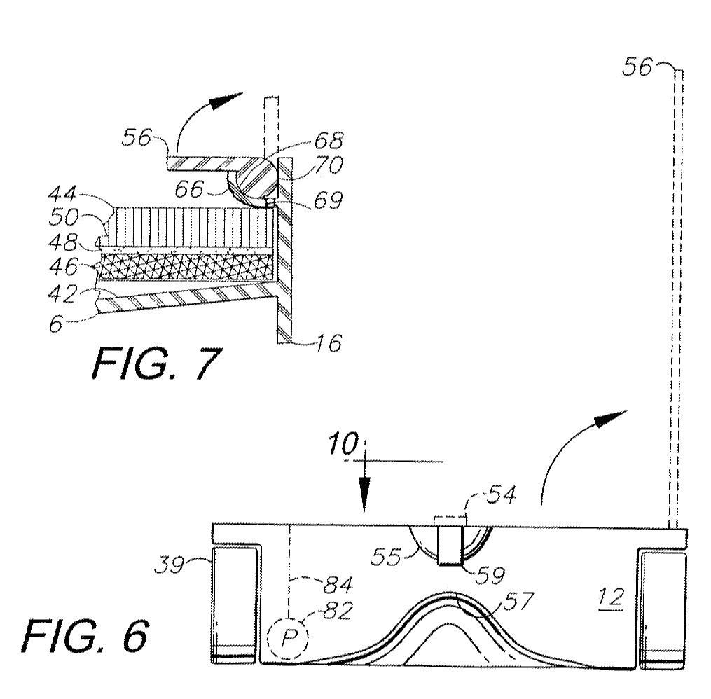

In operation, the waste receptacle 2 can be placed in a suitable indoor or outdoor location for access by a domestic animal. The cover 56 can be oriented vertically or removed, depending upon the preferences of the animal or animals using the waste receptacle 2. A turf inset 76 can be removably installed in the central area of the turf layer 50 and can comprise a suitable material. For example, natural turf can be utilized for the inset 76 in order to train an animal to utilize the waste receptacle 2 in lieu of a natural, grass-covered area. When appropriate, the natural turf inset 76 can be replaced by an artificial turf inset. The inset 76 and the drain plug 26 can be treated with Pheromones or other animal-attractants in order to encourage animals to use the waste receptacle 2. The drain plug is placed in its open position (FIG. 8). A clear plastic level indicator 78 is set into the front wall 14 for providing an external visual reference indicating the level of liquid in the receptacle base interior compartment 18. When the liquid reaches a certain predetermined level indicating a full compartment 18, the waste receptacle 2 should be emptied. The contents of the compartment 18 can be discharged through either discharge valve assembly 51, 53. Optionally, a manual or electric discharge pump 82 can be placed in the interior compartment 18 for discharging the contents thereof through a discharge line 84 to the exterior of the waste receptacle 2 (FIG. 6).

The base 4 can be substantially closed by closing the drain inlet assembly 22 and the discharge valve assemblies 51, 53. The cover 56 can be closed and latched whereby the receptacle 2 is configured for transport and storage. The drain plug 26 preferably protrudes above the level of the turf layer 50 and the rim 20 in its open position whereby it would interfere with closing the cover 56. This configuration can provide a reminder to close the drain inlet assembly 22 (FIG. 8) prior to closing the cover 56. The waste receptacle 2 can be used to advantage when traveling with a pet and in locations where access to natural grass is not readily available, such as apartments, hotels, high-rise commercial buildings, etc.

The turf assembly 44 can be removed for cleaning or replacement. The liquid-permeable construction of the turf assembly 44 facilitates passing liquid waste into the receptacle compartment 18 while trapping solid wastes for convenient disposal. The components of the receptacle 2 can be rinsed out, hosed down and otherwise suitably cleaned, disinfected and treated with odor-neutralizing antiseptic cleaners, which can be added to the turf assembly 44 and the compartment 18 as needed.

An alternative, circular configuration turf assembly inset 80 is shown in FIG. 11, and is adapted for placement in the turf layer 50 as described above in connection with the turf inset 76.

III. Alternative Embodiment or Aspect of the Invention 102.

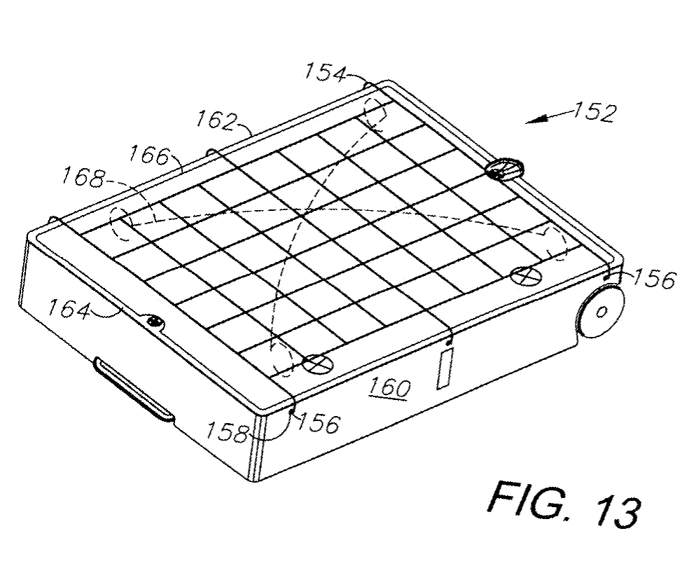

An alternative configuration waste receptacle 102 is shown in FIG. 12 and includes a pair of covers 104, each of which is adapted to swing through approximately 180° between a closed position substantially flush with a base rim 106 and an open position with a slight slope towards a base 108 of the receptacle 102. Folding legs 110 are provided on each cover 104, and are adapted for folding between open, supporting positions (solid lines in FIG. 12) and closed, folded positions (dashed lines in FIG. 12). Either of the covers 104 can be vertically oriented for pets, particularly male dogs, to urinate against. The covers 104 can be positioned at various flat, vertical or sloping positions throughout their respective ranges of motion.

IV. Alternative Embodiment or Aspect of the Invention 152.

FIG. 13 shows a waste receptacle 152 comprising another alternative embodiment of the present invention and mounting a cargo rack 154, which can be formed in a grid-like configuration and constructed of chrome-plated or stainless steel wire, or some other suitable material. The rack 154 includes pins 156, which are adapted for removable placement, e.g. by flexing the rack 154, in receivers 158 formed in front and back walls 160, 162 in proximity to a rim 164. The receivers 158 can be preformed in the front and back walls 160, 162, and punched out by a user as needed for mounting the rack 154. The rack 154 is adapted for mounting various items, such as pet care products, accessories and the like. Items mounted on the rack 154 can be secured by suitable straps, such as bungee cords 168 or elastic straps, which can be hooked into the grid formed by the rack 154. Alternatively, the rack 154 can be omitted and bungee cords and elastic straps can be hooked directly into the receivers 158 for securing items onto a cover 166 of the waste receptacle 152. Still further, a cargo-type net can be mounted on the waste receptacle 152 over the cover 166 using the receivers 158.

V. Alternative Embodiment or Aspect of the Invention 202.

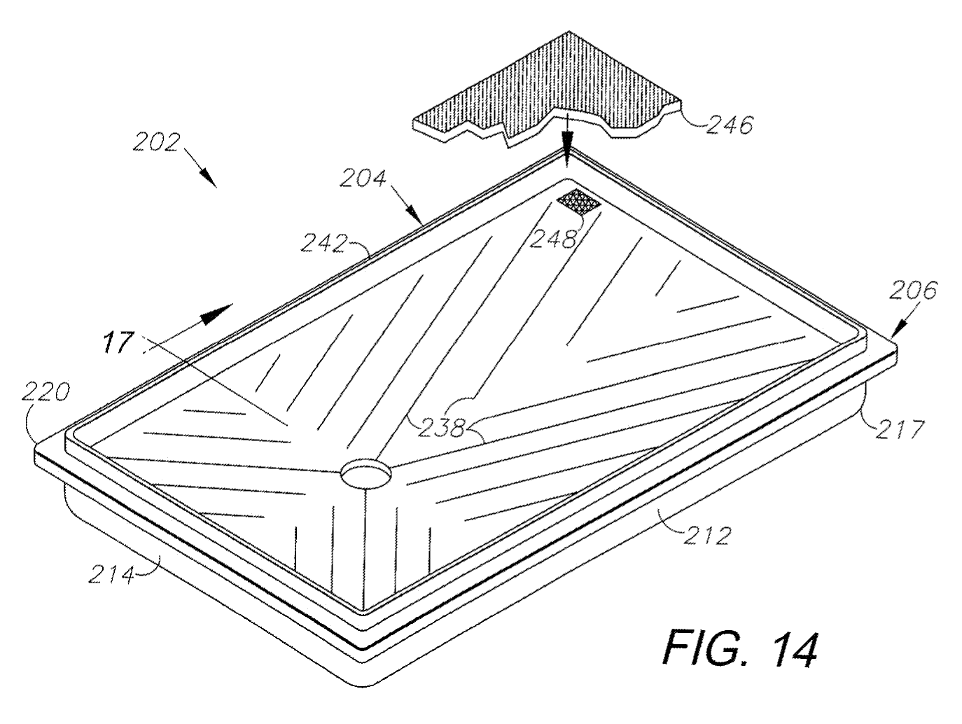

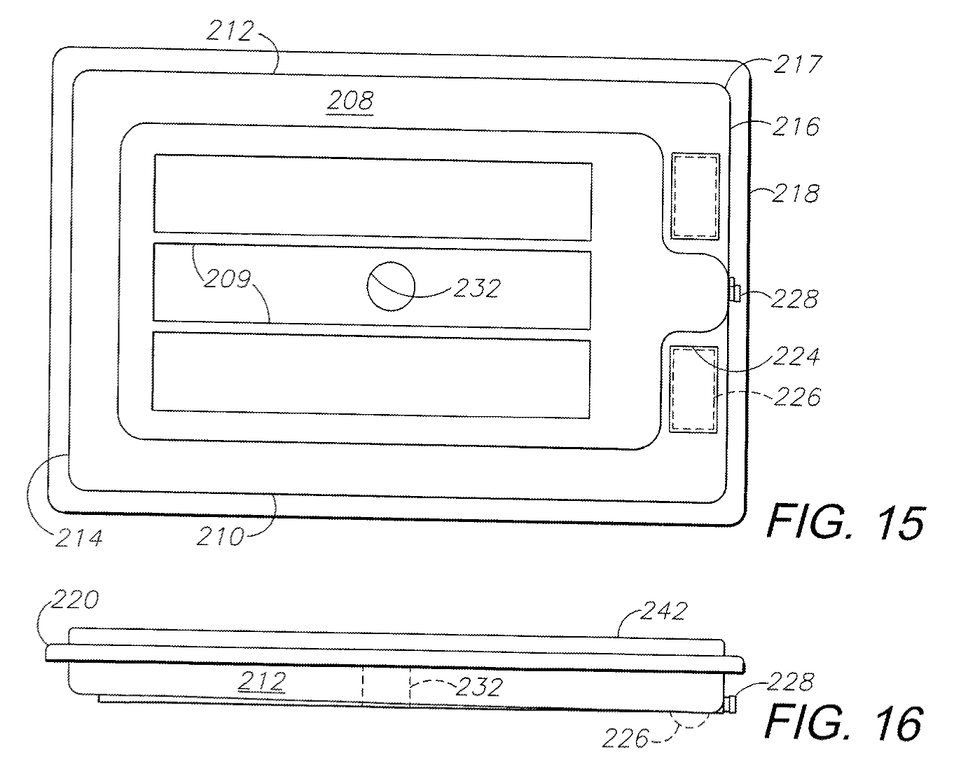

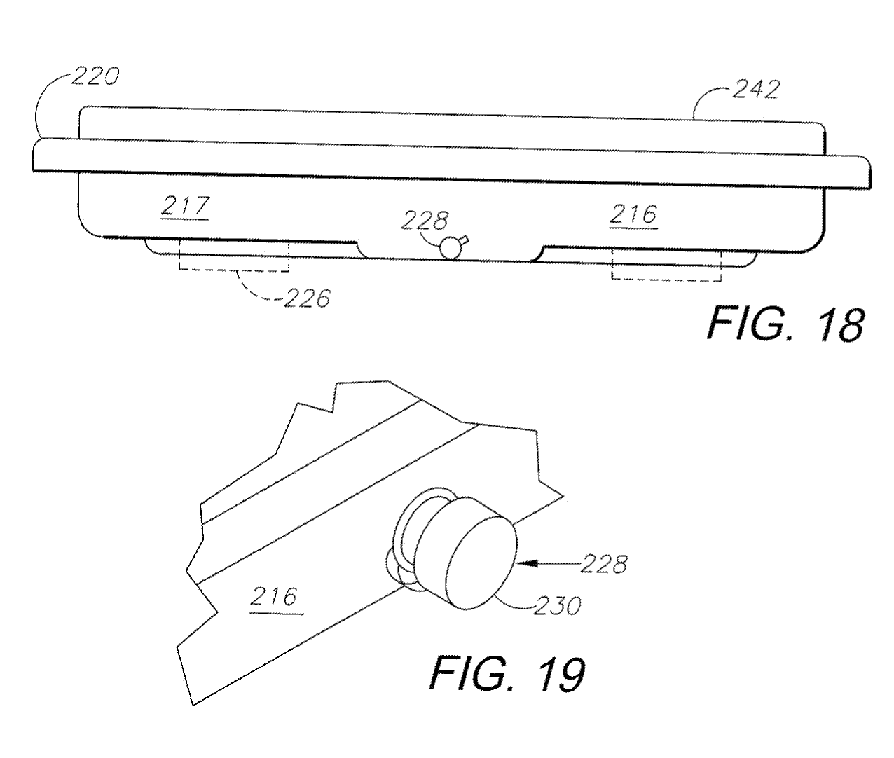

A waste receptacle 202 comprising yet another aspect or embodiment of the present invention is shown in FIGS. 14-19, and includes a receptacle base 204 with a top 206, a bottom panel 208, a left sidewall 210, a right sidewall 212, a front wall 214 and a back wall 216. The bottom panel 208 and the walls 210, 212, 214, 216 form a waste pan 217 and are preferably manufactured from a thermoplastic material, for example by a vacuum forming or other suitable process. A waste pan lip 218 as formed at the tops of the walls and is configured for placement in a corresponding top lip 220 whereby the top 206 can be mounted on the waste pan 217. The lips 218, 220 can be sealingly secured together by a suitable adhesive, by welding, by mechanical fasteners such as rivets 222 or by other suitable attachment means. A bead of sealant or a gasket can be placed therebetween to affect a fluid-tight seal.

The bottom panel 208 includes reinforcing ribs 209 and roller receivers 224 in proximity to the back wall 216 for mounting detachable rollers 226. A drain 228 is provided in the back wall 216 and includes a detachable cap 230. A drain or drains can be provided at alternative locations on the receptacle base 204. The base 204 includes a support column 232, which extends upwardly from the bottom panel 208 and provides support for the top panel 206.

The top 206 includes a top panel 234 with a drain opening 236 located approximately midway between the sidewalls 208, 210 and relatively close to the front wall 214. The top panel 234 slopes downwardly to the drain opening 236 for positive drainage and includes multiple ribs 238 for reinforcing and improved stiffness for supporting the weight of an animal on the receptacle base 204. The opening 236 includes an annular opening flange 240 projecting downwardly into the interior of the waste pan 217.

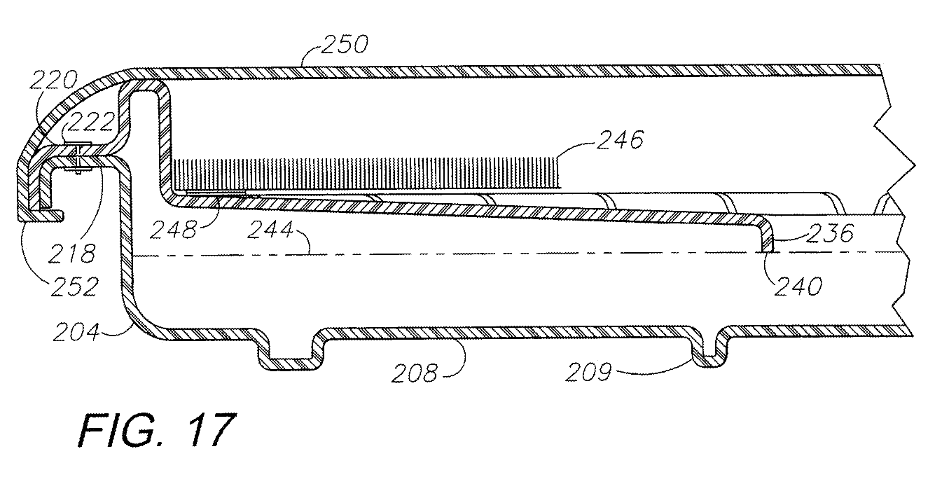

The top 206 includes a rim 242 projecting upwardly from the top panel 234 and mounting the top lip 220, which projects outwardly from the rim 242. As shown in FIG. 17. the configuration of the top 206 tends to trap air above a liquid level 244, which is generally located at the lower edge of the drain opening flange 240. For example, the slope of the top panel 234 and the hollow top rim 242 provide air pockets and vapor traps. In operation, the waste receptacle 202 traps fluid (e.g., animal urine) whereby spillage from overflow can generally be avoided, even with the waste receptacle 202 stood up on its back wall 216 for transport or draining through the discharge drain 228. The inlet drain opening 236 can be closed with a suitable plug or stopper, but is positioned in proximity to the front wall 214 such that the liquid level is below the inlet drain opening 236 with the waste receptacle 202 stood up on its back wall 216.

A suitable waste tray assembly 246 can comprise, for example, artificial turf, and is placed on the top panel 234 in covering relation thereover and secured by suitable hook-and-loop fasteners 248. The waste tray assembly 246 can also comprise a construction such as the turf assembly 44 described above, or natural turf. An optional lid 250 includes a lid flange 252, which is adapted for snapping over the flange waste pan and top lips 218, 220 respectively.

VI. Alternative Embodiment or Aspect of the Invention 302.

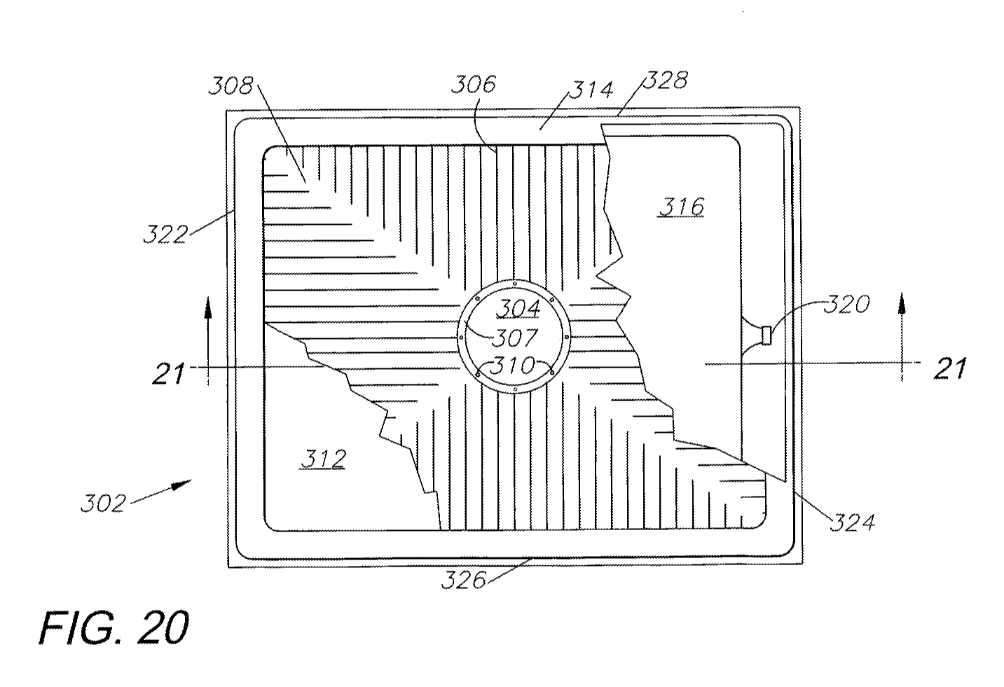

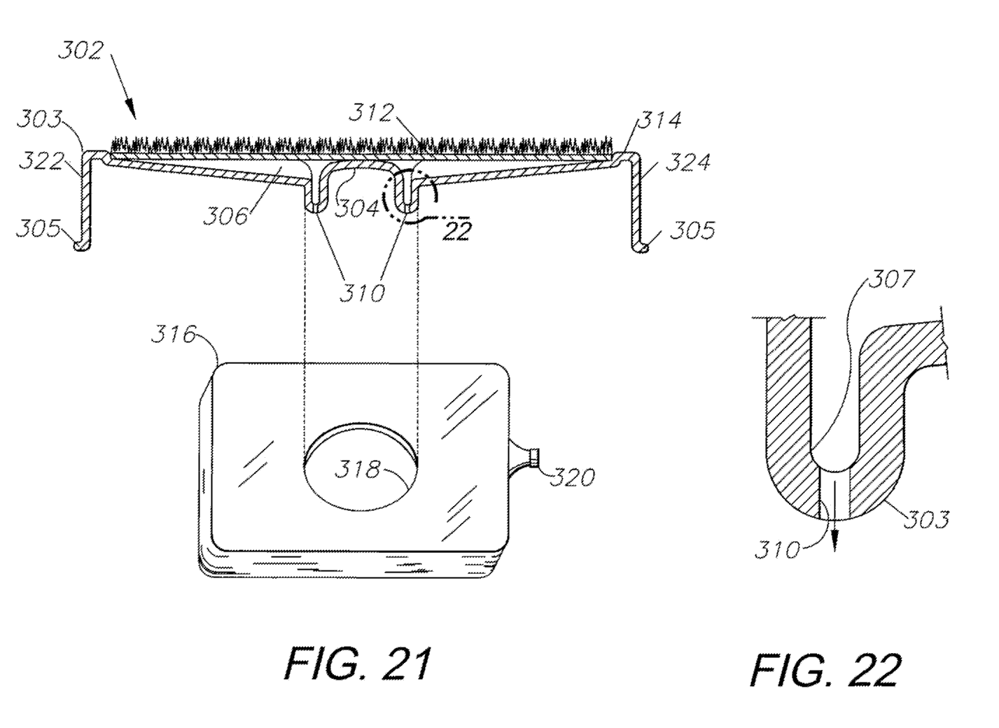

A waste receptacle 302 comprising yet another embodiment or aspect of the present invention is shown in FIGS. 20-22, and includes a disposal system base 303 which includes an angled drip tray 308, a left sidewall 322, a right sidewall 324, a front wall 326, a back wall 328, a base lip 314, a base flange 305, a dome support 304 and support ridges 306. The entire base 303 is preferably manufactured from a thermoplastic material, for example by vacuum forming or other suitable process. A liquid waste container 316 sits below the base 303 and is encompassed within it. The dome support 304 of the base 303 contains drain holes 310 at the bottom of a drain channel 307 where liquid waste drains to from the angled drip tray 308. The dome drain channel 307 inside an access port 318 to the liquid waste container 316 and the liquid waste drains into the liquid waste container 316 via the drain holes 310.

The base walls 322, 324, 326, 328 incorporate a base lip 314 which prevents liquid waste from spilling outside of the grass or turf supporting area and assures all liquid waste will drain down the angled drip tray 308. Each of the walls 322, 324, 326, 328 includes a base flange 305 which sits on the floor or other surface and provides support. The support dome 304 and the support ridges 306 which are raised from the angled drip tray 308 are also included in the base 303. The entire base assembly 303 could be manufactured from one mold, but need not be so.

The support dome 304 and support ridges 306, which rise out of the base 303 and above the angled drip tray 308 can support a waste tray 312 which contains turf made of grass or some other suitable permeable material for covering the waste tray 312. The waste tray 312 can be similar to the turf assembly 44 described above. The waste tray 312 containing turf made of grass or other permeable material allows liquid waste to drain through it down onto the angled drip tray 308, into the drain holes 310 and eventually into the liquid waste container 316 where it will remain stored until the base 303 is removed and the liquid waste is disposed of. Solid waste will remain on top of the grass 312 and will be supported by the support dome and ridges.

The liquid waste container 316 is filled via the access port 318. The container is held in place by the drain channel 307 of the support dome 304 and is filled via the drain holes 310. To access the liquid waste container 316, one simply lifts the base 303 off the container 316. The container 316 is then accessible and can be moved and then drained via the pour spout 320. The liquid waste container 316 would preferably be manufactured from a semi-transparent thermoplastic material to allow the user to visualize the level of liquid waste within the container immediately upon lifting the base 303.

It is to be understood that the invention can be embodied in various forms, and is not to be limited to the examples discussed above. Other components and configurations can be utilized in the practice of the present invention. For example, waste receptacles embodying aspects of the present invention can be scaled to a wide range of appropriate sizes, and can be manufactured from a wide range of suitable materials utilizing appropriate manufacturing procedures.

Having thus described the invention what is claimed as new and desired to be secured by Letters Patent is:

1. A waste receptacle, which comprises:
a base including sidewalls and a drip tray with a drain opening;
a liquid waste container including an inlet port fluidically communicating with said drip tray drain opening and located generally within said base under said drip tray; and
a permeable tray cover located on said drip tray.

2. The waste receptacle according to claim 1, which includes:
said drip tray including a centrally-located dome support and a drain channel generally surrounding said dome support;
said drain opening being located in said drain channel; and
said drain channel being positioned in said container inlet port with said container positioned in said base.

3. The waste receptacle according to claim 2, which includes:
said drip tray sloping downwardly towards said drain channel; and
said drip tray including an upper surface and multiple, support ridges extending upwardly from said drip tray upper surface; and
said support ridges supporting said tray cover.

4. The waste receptacle according to claim 3, which includes:
said drip tray including an upper, perimeter base lip generally surrounding said tray cover; and
each said sidewall having a lower, base flange adapted for supporting said base on a surface.

5. The waste receptacle according to claim 2, which includes:
said drain channel fitting in said container in a friction-fit engagement;
said drain channel including multiple said drain holes in circumferentially-spaced relation; and
said container being semi-transparent and including a pour spout selectively closed by a cap.

6. The waste receptacle according to claim 2 wherein said cover includes a turf layer comprising natural turf, artificial turf or both.

7. The waste receptacle according to claim 3, which includes:
said support ridges being arranged in multiple ridge sets positioned in spaced relation on said drip tray upper surface and separated by drain troughs formed therebetween; and
said drain troughs extending from a perimeter of said drip tray to said drain channel for directing liquid flow thereto.

8. A waste receptacle, which comprises:
a base including front, back and opposite sidewalls and a drip tray supported by said sidewalls;
each said sidewall terminating at a lower base flange adapted for supporting said base on a support surface;
said base including an upper drip tray with a centrally-located dome support generally surrounded by an annular drain channel with multiple, circumferentially-spaced drain holes;
said base further including an upper lip located adjacent the tops of the sidewalls and generally surrounding said drip tray and protruding upwardly therefrom;
a liquid waste container including an inlet port fluidically communicating with said drip tray drain opening and located generally within said base under said drip tray;
a permeable tray cover located on said drip tray generally within said base upper lip;
said drip tray sloping downwardly towards said drain channel;
said drip tray including an upper surface and multiple, support ridges extending upwardly from said drip tray upper surface;
said support ridges being arranged in multiple ridge sets positioned in spaced relation on said drip tray upper surface and separated by drain troughs formed therebetween;
said drain troughs extending from a perimeter of said drip tray to said drain channel for directing liquid flow thereto;
said drain channel fitting in said container inlet port in a friction-fit engagement;
said drain channel including multiple said drain holes in circumferentially-spaced relation;
said container being semi-transparent and including a pour spout selectively closed by a cap; and
said turf layer comprising natural turf, artificial turf or both.
